(19) United States
(12) Patent Application Publication
(10) Pub. No.: US 2014/0028233 A1
(43) Pub. Date: Jan. 30, 2014

(54) MOTOR DRIVE OVERCURRENT BLOCKING CIRCUIT, MOTOR DRIVING CIRCUIT AND METHOD FOR BLOCKING OVERCURRENT THEREOF

(71) Applicant: Samsung Electro-Mechanics Co., Ltd., Gyeonggi-do (KR)

(72) Inventor: Soo Woong Lee, Gyeonggi-do (KR)

(73) Assignee: Samsung Electro-Mechanics Co., Ltd., Gyeonggi-do (KR)

(21) Appl. No.: 13/950,251

(22) Filed: Jul. 24, 2013

(30) Foreign Application Priority Data
Jul. 25, 2012 (KR) 10-2012-0081325

(51) Int. Cl. H02P 29/00

(52) U.S. Cl. CPC H02P 29/0033
USPC 318/474

(57) ABSTRACT

The present invention relates to a motor drive overcurrent blocking circuit, a motor driving circuit, and a method for blocking an overcurrent in a motor driving circuit. The motor drive overcurrent blocking circuit includes: a motor driving unit switched according to a driving control signal to drive a motor; an overcurrent sensing unit connected between a lower end of the sink switching element group and a ground to sense a current flowing in the turned-on switching element of the sink switching element group in the sensing terminal; and an overcurrent blocking unit turned on according to a voltage due to an overcurrent sensed by the overcurrent sensing unit and blocking the overcurrent by sinking the driving control signal applied to the turned-on switching element of the sink switching element group to the ground is provided.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2012-0081325, entitled filed Jul. 25, 2012, which is hereby incorporated by reference in its entirety into this application.”

### BACKGROUND OF THE INVENTION

1. Field of the Invention

The present invention relates to a motor drive overcurrent blocking circuit, a motor driving circuit and a method for blocking an overcurrent thereof, and more particularly, to a motor drive overcurrent blocking circuit that can block an overcurrent using a switching element without feedback, a motor driving circuit and a method for blocking an overcurrent thereof.

2. Description of the Related Art

In a motor driving circuit for driving a motor, there may be problems such as an excessive speed increase and circuit breakdown due to an overcurrent. In order to overcome these problems, various current sensing methods and current blocking methods using an additional circuit which compares a voltage due to an overcurrent with a reference voltage and gives feedback have been used.

A conventional motor driving circuit having a typical structure is shown in FIG. 4.

Referring to FIG. 4, a motor driving circuit includes a motor driving unit 1 including switching elements M1 to M4 which form an H-bridge, a current sensing unit 3 consisting of a sensing resistor Rs, a low pass filter (LPF) 4, a comparator 5, and a control logic (or driving control unit) 9. In the motor driving circuit, a Vsense node checks an overcurrent flowing in the circuit. Vsense is determined by multiplication of the sensing resistor Rs and a current flowing in the sensing resistor. The sensed Vsense is transmitted to the comparator 5 after removing a high-frequency noise component through the LPF 4 consisting of a resistor R_{F} and a capacitor C_{F}. The comparator 5 compares a preset reference voltage signal Vref with the Vsense voltage signal from which the high-frequency noise is removed and outputs high when the Vsense voltage is high. The high output of the comparator 5 blocks a pre-control signal, for example, a gate driver input signal from being transmitted to a driving control signal applying unit, for example, a gate driver from a control signal generating unit. Since the driving control signal applying unit, for example, the gate driver can't exhibit an output, the entire motor driving circuit doesn't operate through feedback.

### RELATED ART DOCUMENT

### Patent Document

Patent Document 1: Korean Patent Laid-open Publication No. 10-2006-0045357 (laid-open on May 17, 2006)

Patent Document 2: Japanese Patent Laid-open Publication No. 2010-161914 (laid-open on Jul. 22, 2010)

### SUMMARY OF THE INVENTION

The conventional method blocks an overcurrent using an additional circuit which compares a voltage due to an overcurrent with a reference voltage and gives feedback.

The present invention has been invented in order to overcome the above-described problems and it is, therefore, an object of the present invention to provide a technology that can overcome an overcurrent of a motor driving circuit in a switching terminal of the motor driving circuit without feedback or an additional circuit.

In accordance with a first embodiment of the present invention to achieve the object, there is provided a motor drive overcurrent blocking circuit including: a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a sensing terminal for sensing a current; an overcurrent sensing unit connected between a lower end of the sink switching element group and a ground to sense a current flowing in the turned-on switching element of the sink switching element group in the sensing terminal; and an overcurrent blocking unit turned on according to a voltage due to an overcurrent sensed by the overcurrent sensing unit and blocking the overcurrent by sinking the driving control signal applied to the turned-on switching element of the sink switching element group to the ground.

At this time, in another example, the motor drive overcurrent blocking circuit may further include a filter unit for removing a high-frequency noise in the sensing terminal of the overcurrent sensing unit while being connected between the overcurrent sensing unit and the overcurrent blocking unit in parallel with the overcurrent sensing unit.

Further, at this time, the filter unit may comprise capacitors connected between the lower end of the sink switching element group and the ground.

Further, in accordance with an example, the source switching element group may include a P-type first FET and a P-type second FET which operates alternately with the first FET, and the sink switching element group may include an N-type third FET and an N-type fourth FET which operates alternately with the third FET.

At this time, in an example, the overcurrent blocking unit may include N-type fifth and sixth FETs which are turned on according to the voltage of the overcurrent, the fifth FET may have a gate electrode connected to the sensing terminal, a drain electrode connected to a gate electrode of the third FET, and a source electrode connected to the ground, and the sixth FET may have a gate electrode connected to the sensing terminal, a drain electrode connected to a gate electrode of the fourth FET, and a source electrode connected to the ground.

Further, in an example, the source and sink switching element groups may include freewheeling diodes which are connected in parallel with the FETs, respectively.

In accordance with another example, the overcurrent blocking unit may consist of N-type FETs which are turned on according to the voltage of the overcurrent.

Next, in accordance with a second embodiment of the present invention to achieve the object, there is provided a motor driving circuit including: a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a sensing terminal for sensing a current; a driving control unit for applying the driving control signals for controlling the source and sink switching element groups of the motor driving unit; an overcurrent sensing unit connected between a lower end of the sink switching element group and a ground to sense a current flowing in the turned-on switching element of the sink switching element group in the sensing terminal; and an overcurrent blocking unit turned on according to a voltage due to an overcurrent sensed by the overcurrent sensing unit and blocking the overcurrent by sinking the driving control signal applied to the turned-on switching element of the sink switching element group to the ground.

At this time, in accordance with another example, the motor driving circuit may further include a filter unit for removing a high-frequency noise in the sensing terminal of the overcurrent sensing unit while being connected between the overcurrent sensing unit and the overcurrent blocking unit in parallel with the overcurrent sensing unit.

Further, in an example, the source switching element group may include a P-type first FET and a P-type second FET which operates alternately with the first FET, and the sink switching element group may include an N-type third FET and an N-type fourth FET which operates alternately with the third FET.

At this time, in another example, the overcurrent blocking unit may include N-type fifth and sixth FETs which are turned on according to the voltage of the overcurrent, the fifth FET may have a gate electrode connected to the sensing terminal, a drain electrode connected to a gate electrode of the third FET, and a source electrode connected to the ground, and the sixth FET may have a gate electrode connected to the sensing terminal, a drain electrode connected to a gate electrode of the fourth FET, and a source electrode connected to the ground.

In another example, the driving control unit may include a control signal generating unit for generating and outputting a pre-control signal for generating the driving control signal; and a driving control signal applying unit for generating and applying the driving control signal according to the pre-control signal received from the control signal generating unit.

Next, in accordance with a third embodiment of the present invention to achieve the object, there is provided a method for blocking an overcurrent in a motor driving circuit including a source switching element group connected to an upper side of an H-bridge to apply a power voltage to a motor and a sink switching element group connected to a lower side of the H-bridge to sink a current flowing through the motor to a sensing terminal for sensing a current, including the steps of: driving the motor by turning on one switching element of each of the source and sink switching element groups according to a driving control signal; sensing a current flowing in the turned-on switching element of the sink switching element group through a sensing resistor connected between a lower end of the sink switching element group and a ground; and blocking an overcurrent by turning on an overcurrent blocking switching element according to a voltage due to an overcurrent sensed in the step of sensing the current to sink the driving control signal applied to the turned-on switching element of the sink switching element group to the ground.

At this time, in an example, the source switching element group may include P-type first and second FETs, and the sink switching element group may include N-type third and fourth FETs, wherein in the step of driving the motor, the second FET operates alternately with the first FET, and the fourth FET operates alternately with the third FET.

Further, at this time, in another example, the overcurrent blocking switching elements may include N-type fifth and sixth FETs which are turned on according to the voltage of the overcurrent, wherein the fifth FET has a gate electrode connected to the sensing terminal, a drain electrode connected to a gate electrode of the third FET, and a source electrode connected to the ground, and the sixth FET has a gate electrode connected to the sensing terminal, a drain electrode connected to a gate electrode of the fourth FET, and a source electrode connected to the ground. At this time, when the current flowing through the third FET is an overcurrent, in the step of blocking the overcurrent, the fifth FET is turned on to sink the driving control signal applied to the gate electrode of the third FET to the ground, and when the current flowing through the fourth FET is an overcurrent, in the step of blocking the overcurrent, the sixth FET is turned on to sink the driving control signal applied to the gate electrode of the fourth FET to the ground.

Further, in accordance with an example, in the step of blocking the overcurrent, a high-frequency noise of the voltage due to the overcurrent, which turns on the overcurrent blocking switching element, may be removed by a capacitor connected in parallel with the sensing resistor.

In accordance with another example, the method for blocking an overcurrent may further include the step of applying the driving control signals for controlling the source and sink switching element groups before the step of driving the motor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1a is a circuit diagram schematically showing a motor drive overcurrent blocking circuit in accordance with an embodiment of the present invention;

FIG. 1b is a view schematically showing the configuration of a driving control unit which applies a driving control signal to the overcurrent blocking circuit of FIG. 1a in a motor driving circuit in accordance with another embodiment of the present invention;

FIG. 2a is a circuit diagram showing a motor driving operation of the overcurrent blocking circuit of FIG. 1a;

FIG. 2b is a circuit diagram showing an overcurrent blocking operation according to overcurrent sensing of the overcurrent blocking circuit of FIG. 1a;

FIG. 3 is a flowchart schematically showing a method for blocking an overcurrent in a motor driving circuit in accordance with another embodiment of the present invention; and

FIG. 4 is a circuit diagram schematically showing a conventional motor driving circuit.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

First, a motor drive overcurrent blocking circuit in accordance with a first embodiment of the present invention will be specifically described with reference to the drawings. At this time, the reference numeral that is not mentioned in the reference drawing may be the reference numeral that represents the same element in another drawing.

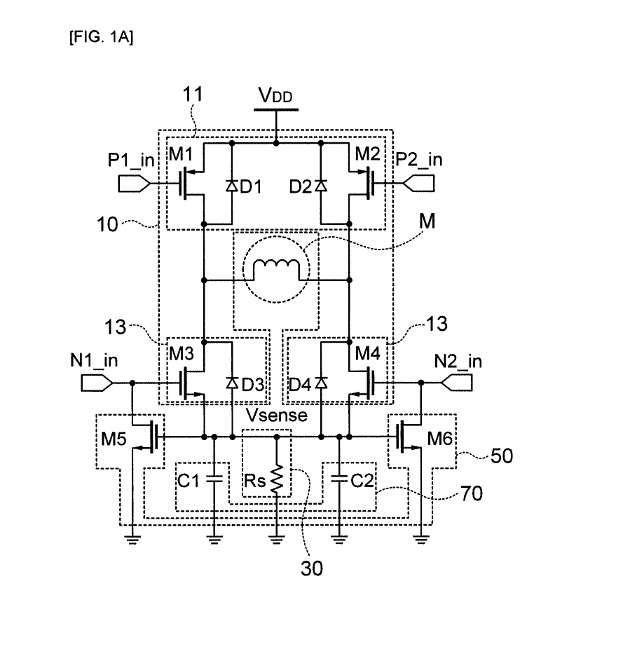

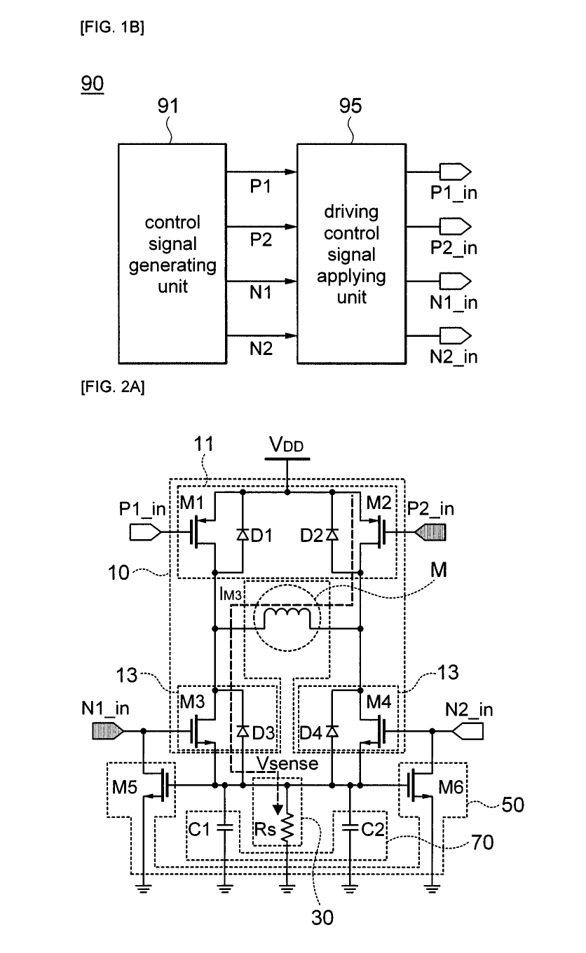

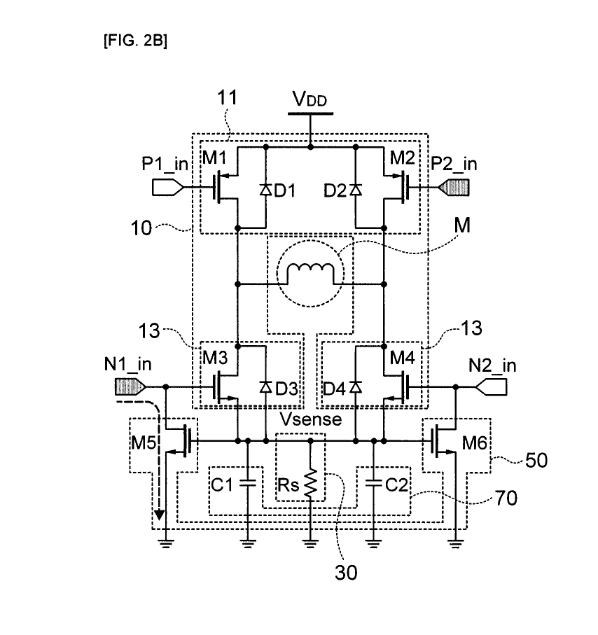

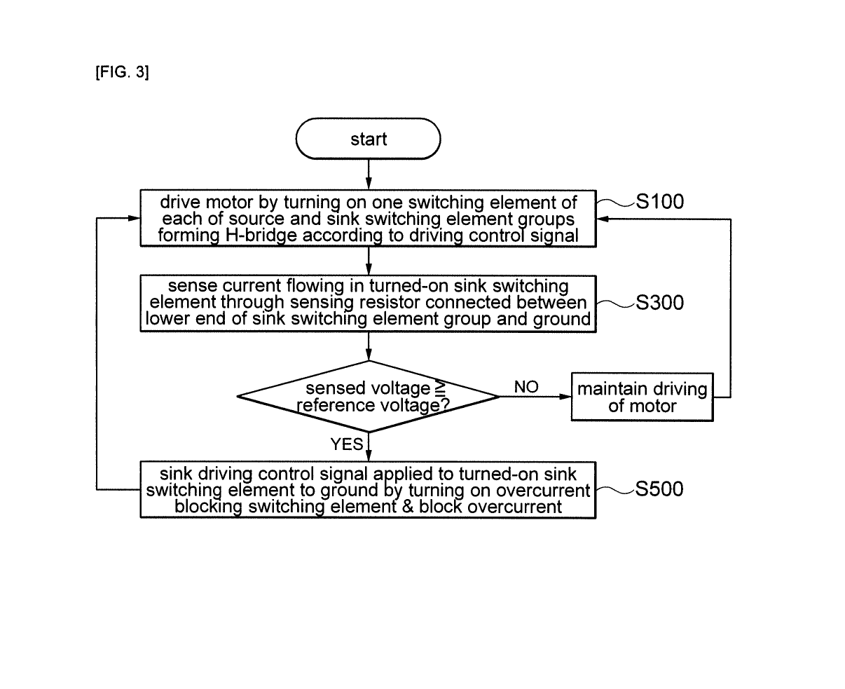

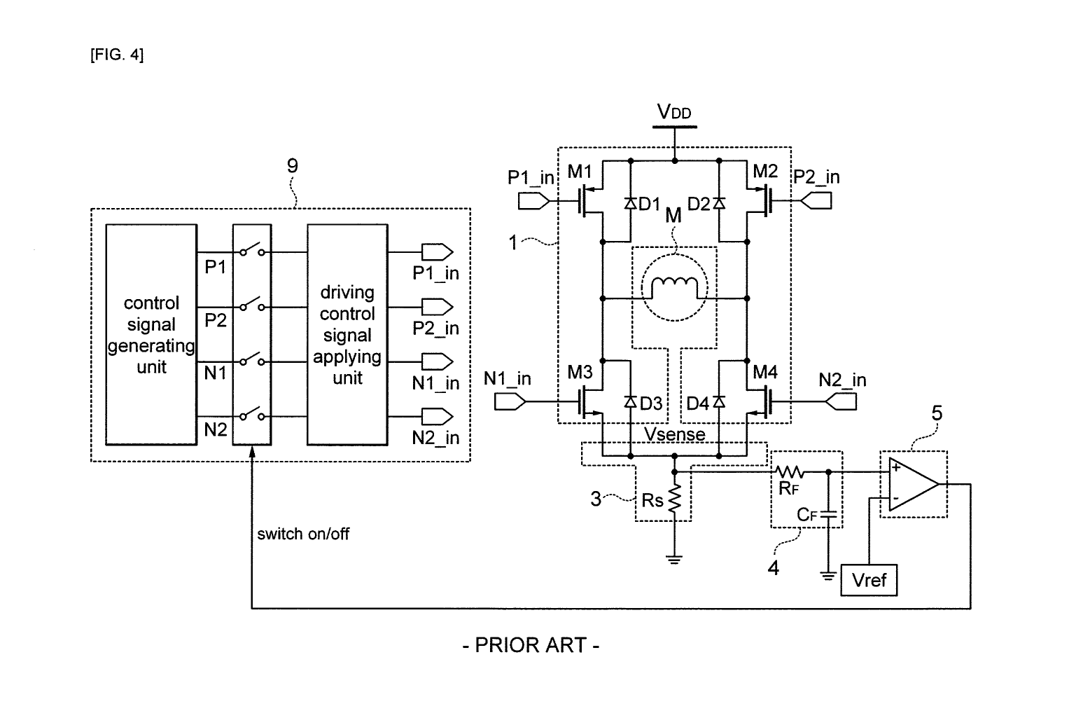

FIG. 1a is a circuit diagram schematically showing a motor drive overcurrent blocking circuit in accordance with an embodiment of the present invention, FIG. 2a is a circuit diagram showing a motor driving operation of the overcurrent blocking circuit of FIG. 1 a, and FIG. 2b is a circuit diagram showing an overcurrent blocking operation according to overcurrent sensing of the overcurrent blocking circuit of FIG. 1a.

Referring to FIG. 1a, a motor drive overcurrent blocking circuit in accordance with an embodiment may include a motor driving unit 10, an overcurrent sensing unit 30, and an overcurrent blocking unit 50. Further, referring to FIG. 1a, in another example, the motor drive overcurrent blocking circuit may further include a filter unit 70.

Specifically, the motor driving unit 10 will be described with reference to FIG. 1a.

The motor driving unit 10 includes a source switching element group 11 and a sink switching element group 13 which form an H-bridge. The source switching element group 11 is connected to a power voltage terminal VDD on an upper side of the H-bridge and applies a power voltage to a motor M according to turn-on. On the other hand, the sink switching element group 13 is connected to a lower side of the H-bridge and sinks a current flowing through the motor M to a sensing terminal for sensing a current. For example, the sink switching element group 13 sinks the current flowing through the motor M to a ground terminal through a sensing resistor Rs connected to the sensing terminal. Although FIG. 1a shows that the motor driving unit 10 is an H-bridge circuit which rotates the motor M forward and backward, an H-bridge circuit which drives a three-phase motor is also possible.

For example, the motor driving unit 10 receives a driving control signal from a driving control unit 90 of FIG. 1b and is turned on according to the driving control signal to drive the motor M. At this time, some elements of the source switching element group 11, for example, one source switching element is turned on, some elements of the sink switching element group 13, for example, one sink switching element is turned on, the power voltage of the power voltage terminal VDD is applied to the motor M through the turned-on source switching element, and an output of the current flowing through the motor M sinks to the ground terminal through the turned-on sink switching element and the sensing resistor Rs.

An example will be specifically described with reference to FIG. 1a. The source switching element group 11 may include a P-type first FET M1 and a P-type second FET M2 which operates alternately with the first FET M1. Further, the sink switching element group 13 may include an N-type third FET M3 and an N-type fourth FET M4 which operates alternately with the third FET M3. The driving control signals, which are opposite to each other, may be applied for alternate switching in the source switching element group 11. Further, the same is for the sink switching element group 13. At this time, the driving control signal applied to the source switching element group 11 and the driving control signal applied to the sink switching element group 13 may have the same or different frequencies or the same frequency but different duty ratios. For example, the driving control signal applied to the source switching element group 11 may have a higher frequency than the driving control signal applied to the sink switching element group 13, the same frequency and duty ratio as the driving control signal applied to the sink switching element group 13, or the same frequency but different duty ratio from the driving control signal applied to the sink switching element group 13.

Further, referring to FIG. 1a, the motor M rotates forward or backward according to the alternate operation of the P-type FETs of the source switching element group 11 and the alternate operation of the N-type FETs of the sink switching element group 13. Although not shown, in case of a three-phase motor, a source switching element group may include three P-type FET elements, and a sink switching element group may include three N-type FET elements. Even at this time, one P-type FET of the source switching element group and one N-type FET of the sink switching element group operate as a pair according to a driving control signal to drive the three-phase motor.

For example, referring to FIG. 2a, when a driving control signal P1_{—}in and a driving control signal N2_{—}in are applied, the P-type first FET M1 of the source switching element group 11 is turned on according to the driving control signal P1_{—}in and the power voltage is applied to the motor M through the first FET M1 to drive the motor M. The N-type fourth FET M4 of the sink switching element group 13 is turned on at the same time according to the driving control signal N2_{—}in so that the current flowing through the motor M sinks to the sensing terminal through the fourth FET M4. That is, the current sunk by the fourth FET M4 sinks to the ground through the sensing resistor Rs. Accordingly, the current flowing in the fourth FET M4 is sensed by the voltage applied to the sensing resistor Rs.

Further, referring to FIG. 1 a, in an example, the source and sink switching element groups 11 and 13 may include freewheeling diodes D1 to D4 which are connected in parallel with the FETs, respectively. The freewheeling diodes D1 to D4, which are anti-parallel diodes, are used to protect the switching elements that drive an inductive load, that is, the motor M. Since the motor M is an inductive load, when a switching signal is changed from on to off, some of the current flowing before remains without being removed at the same time, and at this time, the freewheeling diodes play a role of making a closed loop to allow the remaining current to flow out.

Next, the overcurrent sensing unit 30 will be described with reference to FIG. 1a.

The overcurrent sensing unit 30 is formed between a lower end of the sink switching element group 13 and the ground. At this time, the lower end of the sink switching element group 13 becomes the sensing terminal to which an upper side of the sensing resistor Rs is connected. For example, the overcurrent sensing unit 30 may include the sensing resistor Rs connected between a common node of the lower end of the sink switching element group 13 and the ground. At this time, the overcurrent sensing unit 30 senses the current flowing through the turned-on switching element of the sink switching element group 13, for example, through the sensing resistor Rs. For example, the voltage applied to the sensing resistor Rs is sensed and the sensed voltage may be applied to overcurrent blocking switching elements M5 and M6 of the overcurrent blocking unit 50. Accordingly, when an overcurrent flows, since the voltage sensed through the sensing resistor Rs is higher than a reference voltage, the overcurrent blocking switching elements M5 and M6 can be turned on.

Continuously, the overcurrent blocking unit 50 will be specifically described with reference to FIG. 1a.

The overcurrent blocking unit 50 includes the overcurrent blocking switching elements M5 and M6 which are turned on according to a voltage due to an overcurrent sensed by the overcurrent sensing unit 30. At this time, the overcurrent blocking unit 50 sinks the driving control signal applied to the turned-on switching element of the sink switching element group 13 to the ground according to the turn-on of the overcurrent blocking switching elements M5 and M6. Accordingly, the driving control signal for the turned-on sink switching element is blocked in the motor so that the turned-on sink switching element is turned off, and the overcurrent is blocked.

Referring to FIG. 1a, in an example, the overcurrent blocking unit 50 may consist of N-type FETs which are turned on according to the voltage due to the overcurrent. That is, the voltage sensed through the sensing resistor Rs in the overcurrent sensing unit 30 is higher than a gate reference voltage, the N-type FET is turned on and sinks the driving control signal applied to the turned-on sink switching element to block the driving control signal.

Specifically, referring to FIG. 1 a, in an example, when the sink switching element group 13 includes the N-type third FET M3 and the N-type fourth FET M4 which operates alternately with the third FET M3, the overcurrent blocking unit 50 may include the N-type fifth and sixth FETs M5 and M6 which are turned on according to the voltage of the overcurrent sensed by the overcurrent sensing unit 30. At this time, the N-type fifth FET M5 may have a gate electrode connected to the sensing terminal above the sensing resistor, a drain electrode connected to a gate electrode of the third FET M3, and a source electrode connected to the ground. Further, the N-type sixth FET M6 may have a gate electrode connected to the sensing terminal, a drain electrode connected to a gate electrode of the fourth FET M4, and a source electrode connected to the ground. Accordingly, when gate voltages of the fifth and sixth FETs M5 and M6 are increased due to the overcurrent, the fifth and sixth FETs M5 and M6 are turned on and block the driving control signals, which are signals applied to the gates of the third and fourth FETs M3 and M4, to block the third and fourth FETs M3 and M4.

Next, another example will be described with reference to FIG. 1a. The motor drive overcurrent blocking circuit in accordance with an example may further include a filter unit 70.

In FIG. 1a, the filter unit 70 is connected between the overcurrent sensing unit 30 and the overcurrent blocking unit 50 while being connected in parallel with the overcurrent sensing unit 30. At this time, the filter unit 70 removes a high-frequency noise included in the voltage signal sensed by the sensing terminal of the overcurrent sensing unit 30.

At this time, the filter unit 70 may consist of capacitors C1 and C2 connected between the lower end of the sink switching element group 13 and the ground. That is, the capacitors C1 and C2 may be provided between the gate electrodes of the overcurrent blocking switching elements M5 and M6 of the overcurrent blocking unit 50 and the ground, respectively.

An operation of the motor drive overcurrent blocking circuit in accordance with an example of the present invention will be described.

For example, FIG. 2a shows a motor driving operation when a normal current flows. Referring to FIG. 2a, when the driving control signal P1_{—}in and the driving control signal N2_{—}in are applied at the same time, the P-type first FET M1 of the source switching element group 11 is turned on according to the driving control signal P1_{—}in and the power voltage is applied to the motor M through the first FET M1 to drive the motor M. The N-type fourth FET M4 of the sink switching element group 13 is turned on at the same time according to the driving control signal N2_{—}in and the current flowing through the motor M sinks to the sensing terminal through the fourth FET M4 and flows to the ground through the sensing resistor Rs.

At this time, when an overcurrent flows, a Vsense voltage of the overcurrent sensing terminal is increased. At this time, when the Vsense voltage is higher than the gate reference voltage VTH of the overcurrent blocking switching elements M5 and M6, the overcurrent blocking switching elements M5 and M6 are turned on. Although FIG. 2b shows that only the overcurrent blocking switching element M5 is turned on, the overcurrent blocking switching element M6 is also turned on in FIG. 2b. VDS of the overcurrent blocking switching elements M5 and M6 is reduced according to the turn-on of the overcurrent blocking switching elements M5 and M6. Accordingly, since VGS of the sink switching elements M3 and M4 is reduced, the turned-on sink switching element M3 or M4 is turned off. Further, as the turned-on sink switching element M3 or M4 is turned off, the Vsense voltage is reduced due to reduction of the current by the freewheeling diode. Accordingly, VGS of the overcurrent blocking switching elements M5 and M6 is reduced than VTH, the overcurrent blocking switching elements M5 and M6 are turned off, and a normal switching operation is performed.

That is, when an overcurrent flows, it is possible to implement a systematically simple and stable operation not by overcoming an overcurrent through adjustment of an input of a driving control signal through feedback as before, but by performing an automatic off operation in the switching circuit itself when an overcurrent occurs.

Next, a motor driving circuit in accordance with a second embodiment of the present invention will be specifically described with reference to the drawings. At this time, it is possible to refer to the motor drive overcurrent blocking circuit in accordance with the above-described first embodiment and FIGS. 1a, 2a, and 2b. Thus, repeated descriptions may be omitted.

FIG. 1b is a view schematically showing the configuration of the driving control unit 90 which applies the driving control signal to the overcurrent blocking circuit of FIG. 1a in the motor driving circuit in accordance with another embodiment of the present invention.

The motor driving circuit in accordance with the second embodiment of the present invention includes the motor drive overcurrent blocking circuit in accordance with the above-described first embodiment. Therefore, descriptions of components of the motor driving circuit in accordance with the second embodiment, which repeat the components of the motor drive overcurrent blocking circuit in accordance with the first embodiment, will refer to the above descriptions. At this time, FIG. 1b shows the configuration of the driving control unit 90 which applies the driving control signal to the overcurrent blocking circuit of FIG. 1a.

Referring to FIGS. 1a and 1b, a motor driving circuit in accordance with an example may include a motor driving unit 10, a driving control unit 90, an overcurrent sensing unit 30, and an overcurrent blocking unit 50.

At this time, the motor driving unit 10 includes a source switching element group 11 connected to an upper side of an H-bridge to apply a power voltage to a motor M and a sink switching element group 13 connected to a lower side of the H-bridge to sink a current flowing through the motor M to a sensing terminal for sensing a current. The motor driving unit 10 is switched according to a driving control signal to drive the motor M. Although FIG. 1a shows that the motor driving unit 10 is an H-bridge circuit which rotates the motor M forward and backward, an H-bridge circuit which drives a three-phase motor is also possible.

At this time, referring to FIG. 1a, in an example, the source switching element group 11 may include a P-type first FET M1 and a P-type second FET M2 which operates alternately with the first FET M1, and the sink switching element group 13 may include an N-type third FET M3 and an N-type fourth M4 which operates alternately with the third FET M3.

In an example, the source and sink switching element groups 11 and 13 may include freewheeling diodes D1 to D4 which are connected in parallel with the FETs, respectively.

Next, the driving control unit 90 will be described with reference to FIG. 1b. The driving control unit 90 applies the driving control signals for controlling the source and sink switching element groups 11 and 13 of the motor driving unit 10.

At this time, referring to FIG. 1b, in another example, the driving control unit 90 may include a control signal generating unit 91 and a driving control signal applying unit 95. The control signal generating unit 91 generates and outputs a pre-control signal for generally controlling the speed of the motor M and the like. The pre-control signal is a basic signal for generating the driving control signal. For example, in FIGS. 1b, P1, P2, N1, and N2 are generated and output as the pre-control signals.

Next, the driving control signal applying unit 95 generates the driving control signal according to the pre-control signal received from the control signal generating unit 91 to apply the driving control signal to the motor driving unit 10. For example, in FIG. 1b, a driving control signal P1_{—}in is generated according to the pre-control signal P1, a driving control signal P2_{—}in is generated according to the pre-control signal P2, a driving control signal N1_{—}n is generated according to the pre-control signal N1, a driving control signal N2_{—}in is generated according to the pre-control signal N2, and the driving control signals are applied to the motor driving unit 10.

At this time, the driving control signal applied to the source switching element group 11 and the driving control signal applied to the sink switching element group 13 may have the same or different frequencies or the same frequency and different duty ratios.

Next, the overcurrent sensing unit 30 will be described. The overcurrent sensing unit 30 is formed by connecting, for example, a sensing resistor Rs between a lower end of the sink switching element group 13 and a ground. An upper portion of the sensing resistor Rs becomes the sensing terminal. The overcurrent sensing unit 30 can sense a current flowing in the turned-on switching element of the sink switching element group 13 using the voltage applied to the sensing resistor Rs.

Next, the overcurrent blocking unit 50 will be described. The overcurrent blocking unit 50 includes overcurrent blocking switching elements M5 and M6 which are turned on according to a voltage due to an overcurrent sensed by the overcurrent sensing unit 30. At this time, the overcurrent blocking unit 50 can block the overcurrent by sinking the driving control signal applied to the turned-on switching element of the sink switching element group 13 to the ground in overcurrent blocking switching elements M5 and M6.

At this time, referring to FIG. 1a, in another example, the overcurrent blocking unit 50 may include the N-type fifth and sixth FETs M5 and M6 which are turned on according to the voltage of the overcurrent. For example, when the sink switching element group 13 includes the N-type third and fourth FETs M3 and M4, the fifth FET M5 may have a gate electrode connected to the sensing terminal, a drain electrode connected to a gate electrode of the third FET M3, and a source electrode connected to the ground. Further, the sixth FET M6 may have a gate electrode connected to the sensing terminal, a drain electrode connected to a gate electrode of the fifth FET M4, and a source electrode connected to the ground.

Further, referring to FIG. 1a, in another example, the motor driving circuit may further include a filter unit 70. The filter unit 70 is connected between the overcurrent sensing unit 30 and the overcurrent blocking unit 50 while being connected in parallel with the overcurrent sensing unit 30. At this time, the filter unit 70 can remove a high-frequency noise included in the signal sensed by the sensing terminal of the overcurrent sensing unit 30. For example, the filter unit may consist of a capacitor.

Next, a method for blocking an overcurrent in a motor driving circuit in accordance with a third embodiment of the present invention will be specifically described with reference to the drawings. At this time, it is possible to refer to the motor drive overcurrent blocking circuit in accordance with the above-described first embodiment, the motor driving circuit in accordance with the above-described second embodiment, and FIGS. 1a, 1b, 2a, and 2b. Thus, repeated descriptions may be omitted.

FIG. 3 is a flowchart schematically showing a method for blocking an overcurrent in a motor driving circuit in accordance with another embodiment of the present invention.

Referring to FIG. 3, a method for blocking an overcurrent in a motor driving circuit in accordance with an example is applied to a motor driving circuit including a source switching element group 11 connected to an upper side of an H-bridge to apply a power voltage to a motor M and a sink switching element group 13 connected to a lower side of the H-bridge to sink a current flowing through the motor M to a sensing terminal for sensing a current. At this time, the method for blocking an overcurrent in a motor driving circuit may include a motor driving step S100, a current sensing step S300, and an overcurrent blocking step S500. Further, in accordance with an example, although not shown, the method for blocking an overcurrent in a motor driving circuit may further include a motor driving signal applying step before the motor driving step S100.

Specifically, in the motor driving step S100 of FIG. 3, one switching element of each of the source and sink switching element groups 11 and 13 is turned on according to a driving control signal to drive the motor M. Although FIG. 1a shows that the motor driving unit 10 is an H-bridge circuit which rotates the motor M forward and backward, an H-bridge circuit which drives a three-phase motor is also possible.

Referring to FIG. 1a, in an example, the source switching element group 11 includes P-type first and second FETs M1 and M2, and the sink switching element group 13 includes N-type third and fourth FETs M3 and M4. At this time, in the motor driving step S100 of FIG. 3, the second FET M2 operates alternately with the first FET M1 and the fourth FET M4 operates alternately with the third FET M3 to drive the motor M.

For example, a driving control signal P1_{—}in and a driving control signal P2_{—}in may be alternately applied to the source switching element group 11, and a driving control signal N1_{—}in and a driving control signal N2_{—}in may be alternately applied to the sink switching element group 13. At this time, the driving control signal applied to the source switching element group 11 and the driving control signal applied to the sink switching element group 13 may have the same or different frequencies or the same frequency and different duty ratios.

Referring to MG. 2a, when the driving control signal P1_{—}in and the driving control signal N2_{—}in are applied at the same time, the P-type first FET M1 of the source switching element group 11 is turned on according to the driving control signal P1_{—}in and the power voltage is applied to the motor M through the first FET M1 to drive the motor M. The N-type fourth FET M4 is turned on at the same time according to the driving control signal N2_{—}in and the current flowing in the motor M sinks to the sensing terminal through the fourth FET M4 and flows to the ground through a sensing resistor Rs.

In an example, the source and sink switching element groups 11 and 13 may have freewheeling diodes D1 to D4 which are connected in parallel with the FETs, respectively.

Next, in the current sensing step S300 of FIG. 3, a current flowing in the turned-on switching element of the sink switching element group 13 is sensed through the sensing resistor Rs connected between a lower end of the sink switching element group 13 and the ground.

Next, in the overcurrent blocking step S500 of FIG. 3, overcurrent blocking switching elements M5 and M6 are turned on according to a voltage of an overcurrent sensed in the current sensing step S300, that is, the voltage applied to the sensing resistor Rs. According to the turn-on of the overcurrent blocking switching elements M5 and M6, the driving control signal applied to the turned-on switching element of the sink switching element group 13 sinks to the ground. Accordingly, the overcurrent is blocked.

At this time, referring to FIG. 1 a, the overcurrent blocking switching elements include the N-type fifth and sixth FETs M5 and M6 which are turned on according to the voltage of the overcurrent. At this time, when the sink switching element group 13 includes the N-type third and fourth FETs M3 and M4, the fifth FET M5 may have a gate electrode connected to the sensing terminal, a drain electrode connected to a gate electrode of the third FET M3, and a source electrode connected to the ground. Further, the fifth FET M6 may have a gate electrode connected to the sensing terminal, a drain electrode connected to a gate electrode of the fourth FET M4, and a source electrode connected to the ground.

At this time, in an example, when the current flowing through the third FET M3 is an overcurrent, in the overcurrent blocking step, the fifth FET M5 is turned on to sink the driving control signal applied to the gate electrode of the third FET M3 to the ground. Further, when the current flowing through the fourth FET M4 is an overcurrent, in the overcurrent blocking step, the sixth FET M6 is turned on to sink the driving control signal applied to the gate electrode of the fourth FET M4 to the ground.

Further, referring to FIG. 1a, in an example, in the overcurrent blocking step S500 of FIG. 3, a high-frequency noise of the voltage of the overcurrent which turns on the overcurrent blocking switching elements may be removed by a capacitor connected in parallel with the sensing resistor Rs.

Although not shown, a method for blocking an overcurrent in a motor driving circuit in accordance with another example will be described. At this time, the method for blocking an overcurrent in a motor driving circuit may further include the step for applying the driving control signals for controlling the source and sink switching element groups 11 and 13 before the motor driving step S100 of FIG. 3.

According to embodiments of the present invention, it is possible to overcome an overcurrent of a motor driving circuit in a switching terminal of the motor driving circuit without feedback or an additional circuit.

That is, according to embodiments of the present invention, it is possible to adjust a switching element itself in a driving circuit without turning on/off a switch for generating and applying a driving control signal for blocking an overcurrent and remove the need for feedback.

Accordingly, it is possible to implement a continuous operation of a motor without loss of time.

Further, it is possible to implement a simple circuit configuration since there is no need for additional configuration of a comparator or a control logic circuit as before.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A motor drive overcurrent blocking circuit comprising:
a motor driving unit switched according to a driving control signal to drive a motor while comprising a source switching element group connected to an upper side of an H-bridge to apply a power voltage to the motor and a sink switching element group connected to a lower side of the H-bridge to sink a current flowing through the motor to a sensing terminal for sensing a current;
an overcurrent sensing unit connected between a lower end of the sink switching element group and a ground to sense a current flowing in the turned-on switching element of the sink switching element group in the sensing terminal; and
an overcurrent blocking unit turned on according to a voltage due to an overcurrent sensed by the overcurrent sensing unit and blocking the overcurrent by sinking the driving control signal applied to the turned-on switching element of the sink switching element group to the ground.

2. The motor drive overcurrent blocking circuit according to claim 1, further comprising:
a filter unit for removing a high-frequency noise in the sensing terminal of the overcurrent sensing unit while being connected between the overcurrent sensing unit and the overcurrent blocking unit in parallel with the overcurrent sensing unit.

3. The motor drive overcurrent blocking circuit according to claim 2, wherein the filter unit comprises capacitors connected between the lower end of the sink switching element group and the ground.

4. The motor drive overcurrent blocking circuit according to claim 1, wherein the source switching element group comprises a P-type first FET and a P-type second FET which operates alternately with the first FET, and the sink switching element group comprises an N-type third FET and an N-type fourth FET which operates alternately with the third FET.

5. The motor drive overcurrent blocking circuit according to claim 4, wherein the source and sink switching element groups comprise freewheeling diodes which are connected in parallel with the FETs, respectively.

6. The motor drive overcurrent blocking circuit according to claim 1, wherein the overcurrent blocking unit consists of N-type FETs which are turned on according to the voltage of the overcurrent.

7. The motor drive overcurrent blocking circuit according to claim 2, wherein the overcurrent blocking unit consists of N-type FETs which are turned on according to the voltage of the overcurrent.

8. The motor drive overcurrent blocking circuit according to claim 4, wherein the overcurrent blocking unit consists of N-type FETs which are turned on according to the voltage of the overcurrent.

9. The motor drive overcurrent blocking circuit according to claim 4, wherein the overcurrent blocking unit comprises N-type fifth and sixth FETs which are turned on according to the voltage of the overcurrent,
the fifth FET has a gate electrode connected to the sensing terminal, a drain electrode connected to a gate electrode of the third FET, and a source electrode connected to the ground, and
the sixth FET has a gate electrode connected to the sensing terminal, a drain electrode connected to a gate electrode of the fourth FET, and a source electrode connected to the ground.

10. A motor driving circuit comprising:
a motor driving unit switched according to a driving control signal to drive a motor while comprising a source switching element group connected to an upper side of an H-bridge to apply a power voltage to the motor and a sink switching element group connected to a lower side of the H-bridge to sink a current flowing through the motor to a sensing terminal for sensing a current;
a driving control unit for applying the driving control signals for controlling the source and sink switching element groups of the motor driving unit;
an overcurrent sensing unit connected between a lower end of the sink switching element group and a ground to sense a current flowing in the turned-on switching element of the sink switching element group in the sensing terminal; and
an overcurrent blocking unit turned on according to a voltage due to an overcurrent sensed by the overcurrent sensing unit and blocking the overcurrent by sinking the driving control signal applied to the turned-on switching element of the sink switching element group to the ground.

11. The motor driving circuit according to claim 10, further comprising:
a filter unit for removing a high-frequency noise in the sensing terminal of the overcurrent sensing unit while being connected between the overcurrent sensing unit and the overcurrent blocking unit in parallel with the overcurrent sensing unit.

12. The motor driving circuit according to claim 10, wherein the source switching element group comprises a P-type first FET and a P-type second FET which operates alternately with the first FET, and the sink switching element group comprises an N-type third FET and an N-type fourth FET which operates alternately with the third FET.

13. The motor driving circuit according to claim 12, wherein the overcurrent blocking unit comprises N-type fifth and sixth FETs which are turned on according to the voltage of the overcurrent,
the fifth FET has a gate electrode connected to the sensing terminal, a drain electrode connected to a gate electrode of the third FET, and a source electrode connected to the ground, and
the sixth FET has a gate electrode connected to the sensing terminal, a drain electrode connected to a gate electrode of the fourth FET, and a source electrode connected to the ground.

14. The motor driving circuit according to claim 10, wherein the driving control unit comprises:
a control signal generating unit for generating and outputting a pre-control signal for generating the driving control signal; and
a driving control signal applying unit for generating and applying the driving control signal according to the pre-control signal received from the control signal generating unit.

15. The motor driving circuit according to claim 11, wherein the driving control unit comprises:
a control signal generating unit for generating and outputting a pre-control signal for generating the driving control signal; and
a driving control signal applying unit for generating and applying the driving control signal according to the pre-control signal received from the control signal generating unit.

16. A method for blocking an overcurrent in a motor driving circuit comprising a source switching element group connected to an upper side of an H-bridge to apply a power voltage to a motor and a sink switching element group connected to a lower side of the H-bridge to sink a current flowing through the motor to a sensing terminal for sensing a current, comprising:
driving the motor by turning on one switching element of each of the source and sink switching element groups according to a driving control signal;
sensing a current flowing in the turned-on switching element of the sink switching element group through a sensing resistor connected between a lower end of the sink switching element group and a ground; and
blocking an overcurrent by turning on an overcurrent blocking switching element according to a voltage due to an overcurrent sensed in sensing the current to sink the driving control signal applied to the turned-on switching element of the sink switching element group to the ground.

17. The method for blocking an overcurrent in a motor driving circuit according to claim 16, wherein the source switching element group comprises P-type first and second FETs, and the sink switching element group comprises N-type third and fourth FETs, wherein in driving the motor, the second FET operates alternately with the first FET, and the fourth FET operates alternately with the third FET.

18. The method for blocking an overcurrent in a motor driving circuit according to claim 16, wherein in blocking the overcurrent, a high-frequency noise of the voltage due to the overcurrent, which turns on the overcurrent blocking switching element, is removed by a capacitor connected in parallel with the sensing resistor.

19. The method for blocking an overcurrent in a motor driving circuit according to claim 17, wherein the overcurrent blocking switching elements comprise N-type fifth and sixth FETs which are turned on according to the voltage of the overcurrent, wherein
the fifth FET has a gate electrode connected to the sensing terminal, a drain electrode connected to a gate electrode of the third FET, and a source electrode connected to the ground, and the sixth FET has a gate electrode connected to the sensing terminal, a drain electrode connected to a gate electrode of the fourth FET, and a source electrode connected to the ground, wherein
when the current flowing through the third FET is an overcurrent, in blocking the overcurrent, the fifth FET is turned on to sink the driving control signal applied to the gate electrode of the third FET to the ground, and when the current flowing through the fourth FET is an overcurrent, in blocking the overcurrent, the sixth FET is turned on to sink the driving control signal applied to the gate electrode of the fourth FET to the ground.

20. The method for blocking an overcurrent in a motor driving circuit according to claim 16, further comprising, before driving the motor,
applying the driving control signals for controlling the source and sink switching element groups.
